(19) United States
(12) Patent Application Publication
(10) Pub. No.: US 2026/0155449 A1
(43) Pub. Date: Jun. 4, 2026

(54) LITHIUM HYBRID ANODE FOR SECONDARY ELECTROCHEMICAL CELLS

(71) Applicant: NORTHVOLT AB, Stockholm (SE)

(72) Inventors: Hwamyung JANG, Västerås (SE); Léo DUCHËNE, Västerås (SE)

(21) Appl. No.: 19/126,725

(22) PCT Filed: Oct. 16, 2023
(86) PCT No.: PCT/EP2023/078657

§ 371 Date: May 2, 2025

(30) Foreign Application Priority Data
Nov. 3, 2022 (SE) 2251279-2

(51) Int. Cl. H01M 10/058; H01M 4/02; H01M 4/36; H01M 4/38; H01M 4/525; H01M 4/583; H01M 10/052; H01M 10/44

(52) U.S. Cl. CPC H01M 10/058; H01M 4/366; H01M 4/382; H01M 4/525; H01M 4/583; H01M 10/052; H01M 10/446; H01M 2004/027; H01M 2004/028

(57) ABSTRACT

The present invention relates to a method for preparing a secondary electrochemical cell comprising a lithium hybrid anode. In particular, the present invention relates to a method including a pre-intercalation step to form a lithium hybrid anode suitable for a high-performance hybrid lithium metal battery.

### TECHNICAL FIELD OF THE INVENTION

The present invention relates to a method for preparing a secondary electrochemical cell comprising a lithium hybrid anode. In particular, the present invention relates to a method including a pre-intercalation step to form a lithium hybrid anode suitable for a high-performance hybrid lithium metal battery.

### BACKGROUND OF THE INVENTION

Rechargeable batteries having high energy density and discharge voltage, in particular Li-ion batteries, are a vital component in portable electronic devices and are a key enabler for the electrification of transport and large-scale storage of electricity. To reach higher energy densities, new types of batteries are being developed.

State of the art Li-ion batteries typically consists of stacks of secondary electrochemical cells, wherein each cell is composed of a cathode comprising a cathode current collector, an electrolyte, an anode comprising an anode current collector, and optionally a separator positioned between the anode and cathode.

In secondary electrochemical cells where the anodes are made of graphite-based materials and a metal current collector, the cations are extracted from the cathode material and then diffuse from the cathode material through the electrolyte and intercalate into the anode material during charging. During discharge, this process is reversed.

In an effort to increase the energy density, the development has gone towards lithium metal batteries since lithium metal demonstrates a much higher specific capacity and a lower redox potential than graphite. In such batteries, the anode consists of a lithium metal whose corresponding cations carry the current in the electrolyte. However, the use of lithium metal poses several challenges during both manufacturing and cycling of the battery. Lithium metal reacts violently with water and extra precautions are therefore required during assembly of lithium metal battery cells, such as strict dry room conditions, strict waste management and modification of the equipment, to prevent spontaneous ignition. During cycling, lithium metal deposition and dissolution is associated with large volume changes which can reduce the cycling stability of the electrochemical cell.

Another issue with secondary electrochemical cells containing lithium metal is the formation of lithium metal dendrites when the corresponding lithium ion is deposited on the anode. That risk increases upon repetition of charging and discharging cycles or during particularly fast charging conditions. This hampers cycling stability, as some of these dendrites can break off and get electronically disconnected, hence reducing access to otherwise useful charge in the battery. Dendrites also increase the risk for short-circuits in the secondary electrochemical cell, as dendrites can grow through the electrolyte and the separator, thereby putting the anode in contact with the cathode, resulting in serious fire hazards.

Hybrid lithium batteries position themselves between Li-ion and lithium metal batteries, thereby taking advantage of both the high energy density of lithium metal batteries and the good coulombic efficiency and safety of Li-ion batteries. They comprise anodes in which lithium ions are both intercalated into the anode active material and plated onto the anode as metallic lithium. A disadvantage of the phase transfer between lithium ions and lithium metal during charge cycling is that hybrid lithium batteries have markedly shorter cycle life than lithium ion batteries. Another challenge is the low coulombic efficiency caused by the high reactivity of metallic lithium and instability of the solid electrolyte interphase (SEI).

Hence, there is a need to provide secondary lithium batteries with improved performance and safety, which can be manufactured without use of lithium metal. In particular, it would be advantageous to provide secondary lithium batteries with extended cycle life and high capacity and coulombic efficiency.

### SUMMARY OF THE INVENTION

The present invention relates to a method of preparing a secondary electrochemical cell with good performance and improved cycle life. The secondary electrochemical cell comprises a lithium hybrid anode which is pre-intercalated prior to assembling of the cell. The lithium hybrid anode mitigates some of challenges involved with repetitive deposition and stripping of metallic lithium on the anode, resulting in improved cycle life and great performance.

Thus, an object of the present invention relates to the provision of a method for preparing a secondary electrochemical cell, the assembly of which is safe and fast, and results in a secondary electrochemical cell with superior cycle life, coulombic efficiency, and capacity.

In particular, it is an object of the present invention to provide a method for preparing a secondary electrochemical cell that is simple and suitable for large-scale production. Thus, an aspect of the present invention relates to a method for preparing a secondary electrochemical cell, said method comprising the steps of:
(i) providing an anode comprising an anode active material layer;
(ii) providing a first cathode comprising a first lithium ion source;
(iii) partially charging the anode active material layer with lithium ions using the first lithium ion source of said first cathode to provide a pre-intercalated anode;
(iv) assembling a secondary electrochemical cell comprising said pre-intercalated anode and a second cathode comprising a second source of lithium ions;
(v) optionally, charging said secondary electrochemical cell;
   wherein, in the step (iv), the ratio of the pre-intercalated anode capacity to second cathode capacity (N/P ratio) is less than 1.

Another aspect of the present invention relates to a secondary electrochemical cell obtainable by a method as described herein.

Yet another aspect of the present invention relates to an electrochemical cell assembly comprising:
a pre-intercalated anode comprising an anode active material,
a cathode comprising a lithium ion source,
optionally, a separator
   wherein the ratio of the pre-intercalated anode capacity to cathode capacity (N/P ratio) is less than 1.

A still further aspect of the present invention relates to an electrochemical cell comprising:
a pre-intercalated anode comprising an anode active material;
a cathode comprising a lithium ion source;
optionally, a separator;
   wherein, when the cell is charged, the amount of intercalated and plated lithium on the pre-intercalated anode is greater than the capacity of the cathode.

### BRIEF DESCRIPTION OF THE FIGURES

FIG. 1 shows the capacity retention of three secondary electrochemical cells as a function of cycle number. The three electrochemical cells comprised an anode active material pre-intercalated to 25% capacity (25% intercalation occupation) (circles), an anode active material with 25% lithium excess added as lithium metal deposited on the anode layer (triangles), or an anode active material without any pre-intercalation (crosses). Not all cycles are shown for better figure clarity (capacity retention for intermediate cycles were also recoded).

The present invention will in the following be described in more detail.

### DETAILED DESCRIPTION OF THE INVENTION

### Definitions

Prior to outlining the present invention in more details, a set of terms and conventions is first defined:

### Lithium Hybrid Anode

In the present context, the term “lithium hybrid anode” refers to an anode, which when charged comprise both intercalated lithium ions and metallic lithium.

### Capacity

In the present context, the term “capacity” refers to the total coulombic charge that may be stored in a material.

The capacity is preferably given as the areal capacity in units of mAh/cm2.

Herein, “intercalation capacity” refers to coulombic charge that may be stored in the anode active material by intercalation of lithium ions. “Anode capacity” refers to the total coulombic charge that may be stored in the anode. When discharged, the intercalation capacity and anode capacity are the same. When charged, the anode capacity is greater than the intercalation capacity because a metallic lithium layer is deposited on the anode active material.

Intercalation capacities can be determined from theory based on the formula of the fully intercalated species. For instance, for carbonaceous materials, it is known that six carbon atoms can intercalate a lithium ion. The intercalation capacity for graphite is therefore calculated based on an assumed molecular formula of LiCo for fully intercalated graphite. Another example is Li₄Ti₅O₁₂, which can intercalate three lithium ions to form Li₇Ti₅O₁₂.

The areal capacity of the anode can be calculated from the specific capacity of the anode active material (mAh/g) and the mass loading of active material (mg/cm²). The specific capacity of an active material can be calculated from the following formula:
Specific capacity=(n*F)/(3.6*M),
   wherein n is the number of intercalated charges per mole of active material (so would be 1/6 for LiC₆), F is the faraday constant, M is the molecular weight of the active material, and 3.6 is to convert in mAh.

Using this formula the specific capacity of e.g. Li₄Ti₅O₁₂ can be calculated to 175 mAh/g.

The specific capacity of the anode is a different measure of the capacity of the anode, and will be lower than the areal capacity of the anode, when taking into account binders and optional conductive material of the anode.

### Intercalation Occupation

In the present context, the term “intercalation occupation” refers to the fraction of the intercalation capacity that is taken up by lithium ions. For example, an intercalation occupation of 0.5 means that half of the intercalation capacity is loaded with lithium ions. An intercalation occupation of 1 means that the entire intercalation capacity has been exhausted (i.e. no more storage for lithium ions).

### Partially Charging

In the present context, the term “partially charging” refers to charging of the anode so that lithium ions intercalate into the anode active material but without fully occupying the anode active material, i.e. the intercalation occupation of the resulting pre-intercalated anode is less than the intercalation capacity of the anode active material.

### Pre-Intercalated Anode

In the present context, the term “pre-intercalated” refers to an anode comprising anode active material which is partially loaded with lithium ions prior to the first charging cycle.

By the first charging cycle is meant the first charging taking place with the final secondary electrochemical cell which comprises e.g. the final cathodes.

It is to be understood that the pre-intercalated anode is prepared from the anode provided in step (i) of the method. Any descriptive features of the anode (e.g. anode active material, current collector, binder) therefore also applies to the pre-intercalated anode.

### Active Material Mass Loading

In the present context, the term “active material mass loading” refers to a measure of how much active material the anode or cathode comprises. The active material mass loading is preferably given in units of mg/cm2.

### Capacity Retention

In the present context, the term “capacity retention” refers to value that is used to quantify cycle life. The capacity retention is given in percentage as the ratio of the discharge capacity after X cycles to the initial discharge capacity (after formation and pre-conditioning cycles).

### About

Wherever the term “about” is employed herein in the context of amounts, for example absolute amounts, such as numbers, purities, concentrations, weights, sizes, etc., or relative amounts (e.g. percentages, equivalents or ratios), timeframes, and parameters such as temperatures, pressure, etc., it will be appreciated that such variables are approximate and as such may vary by ±10%, for example ±5% and preferably ±2% (e.g. ±1%) from the actual numbers specified. This is the case even if such numbers are presented as percentages in the first place (for example ‘about 10%’ may mean ±10% about the number 10, which is anything between 9% and 11%).

### Method for Preparation of Lithium Hybrid Anodes and Secondary Cells Comprising the Same

Secondary lithium batteries are invaluable components of portable devices and development is rapidly pushed towards obtaining electrochemical cells with higher energy densities to improve and mediate electrification of the transportation industry. Lithium metal batteries have recently been the preferred technology for this purpose due to the attractive high energy density achievable. However, safety issues, low coulombic efficiency and limited cycle life have so far hindered the commercial success of secondary lithium metal batteries.

Herein are described a method for preparing secondary electrochemical cells with high capacity and extended cycle life. The method is safe and does not require handling of lithium metal which is unwanted as it reacts readily with moisture and oxygen in the air, making production of lithium metal batteries complicated and expensive. The secondary electrochemical cell comprises a lithium hybrid anode, which by design is provided with a lower capacity than the cathode in the discharged state. Upon charging, lithium ions will both intercalate into the anode active material and deposit on the anode active material as metallic lithium. A great advantage of the lithium hybrid anode is that it circumvents the need for a pure lithium metal anode and hence facilitates a safe and easily scalable method as lithium metal does not have to be handled separately. Moreover, the large surface area of the anode active material assist in uniform deposition of metallic lithium on the anode and thereby mitigate dendritic growth. Thus, the design of the present secondary electrochemical cell lessen the risk of short circuits during operation of the cell and allow the deposited metallic lithium to function as anode active material, thereby increasing the cell capacity.

The lithium hybrid anode of the present method is pre-loaded with lithium ion prior to form a pre-intercalated anode. Pre-intercalation is achieved by partially charging the anode at a capacity of less than the intercalation capacity of the anode. In this state, the fraction of the anode active material which is occupied by lithium ions, herein referred to as the intercalation occupation, is less than 1. The intercalation occupation of the pre-intercalated anode can easily be tuned by adjusting the capacity of the partial charge. The step of pre-intercalation is performed before the anode is assembled with the remaining components to produce the secondary electrochemical cell. The partial charging of the anode may be performed in an intermediate cell comprising an intermediate cathode which supply the lithium ions. The intermediate cathode is not used in the secondary electrochemical cell.

Thus, an aspect of the present invention relates to a method for preparing a secondary electrochemical cell, said method comprising the steps of:
(i) providing an anode comprising an anode active material layer;
(ii) providing a first cathode comprising a first lithium ion source;
(iii) partially charging the anode active material layer with lithium ions using the first lithium ion source of said first cathode to provide a pre-intercalated anode;
(iv) assembling a secondary electrochemical cell comprising said pre-intercalated anode and a second cathode comprising a second source of lithium ions;
(v) optionally, charging said secondary electrochemical cell;
   wherein, in the step (iv), the ratio of the pre-intercalated anode capacity to second cathode capacity (N/P ratio) is less than 1.

The method described herein produces secondary electrochemical cells with significantly increased cycle life and high capacity and coulombic efficiency. Without being bound by theory, it is contemplated that the pre-intercalation of the anode active material results in a better formation of the solid electrolyte interphase (SEI). In particular, it is contemplated that pre-intercalation of the anode efficiently distribute lithium ions within the anode active material, such as between graphite sheets, to form a “nucleus” from which a more coherent and stable SEI is formed within the first cycles of the battery. This results in lower lithium wastage and fewer side reactions, which ultimately leads to higher coulombic efficiency and therefore also improved cycle life. Some combinations of ranges of intercalation occupation and N/P ratios are preferred since they give a higher charge density. In particular, lower ranges of intercalation occupation and N/P ratios are preferred.

Thus, an embodiment of the present invention relates to the method according as described herein, wherein the intercalation occupation of the pre-intercalated anode is below about 0.8, preferably from about 0.1 to about 0.6, more preferably about 0.1 to about 0.4.

A further embodiment of the present invention relates to the method as described herein, wherein the intercalation occupation of the pre-intercalated anode is below about 0.9, preferably below 0.8, more preferably below 0.7, most preferably below 0.5.

A still further embodiment of the present invention relates to the method as described herein, wherein the intercalation occupation of the pre-intercalated anode is the range of about 0.1 to about 0.9, such as about 0.1 to about 0.7, preferably about 0.2 to about 0.5.

An even further embodiment of the present invention relates to the method as described herein, wherein the intercalation occupation of the pre-intercalated anode is about 0.1, about 0.2, about 0.3, about 0.4, about 0.5, about 0.6 about 0.7, about 0.8, or about 0.9.

Another embodiment of the present invention relates to the method as described herein, wherein the N/P ratio is in the range of about 0.1 to about 0.8, such as about 0.2 to about 0.7, such as about 0.2 to 0.6, such as about 0.2 to about 0.5, such as about 0.3 to 0.5.

Yet another embodiment of the present invention relates to the method as described herein, wherein the N/P ratio is in the range of about 0.1 to about 0.9, such as about 0.1 to about 0.7, such as about 0.2 to about 0.4.

A further embodiment of the present invention relates to the method as described herein, wherein the N/P ratio is about 0.1, about 0.2, about 0.3, about 0.4, about 0.5, about 0.6 about 0.7, about 0.8, or about 0.9.

A still further embodiment of the present invention relates to the method as described herein, wherein the intercalation occupation of the pre-intercalated anode is from about 0.1 to about 0.4, and the N/P ratio is in the range of about 0.2 to about 0.5.

The second cathode must have a sufficient capacity for supplying lithium ions to the anode from the cathode active material in the charging step of the battery. Therefore, the capacity of the second cathode is higher than capacity of the anode (which subsequently becomes the pre-intercalated anode).

Accordingly, an embodiment of the present invention relates to the method as described herein, wherein the second cathode capacity is in the range of about 2 mAh/cm² to about 20 mAh/cm², such as about 2 mAh/cm² to about 15 mAh/cm², such as about 4 mAh/cm² to about 15 mAh/cm^{2 .}

Another embodiment of the present invention relates to the method as described herein, wherein the second cathode capacity is in the range of about 4 mAh/cm² to about 20 mAh/cm², such as about 4 mAh/cm² to about 15 mAh/cm², such as about 5 mAh/cm² to about 10 mAh/cm^{2 .}

A further embodiment of the present invention relates to the method as described herein, wherein the anode capacity is in the range of about 1 mAh/cm² to about 10 mAh/cm², such as about 2 mAh/cm² to about 8 mAh/cm^{2 .}

A still further embodiment of the present invention relates to the method as described herein, wherein the anode capacity is in the range of about 1 mAh/cm² to about 3.5 mAh/cm², such as about 1.5 mAh/cm² to about 3 mAh/cm² .

The relation between the anode active material and second cathode may also be characterised by the amount of active material used. Here it is important to note that active materials can have different specific capacities (mAh/g) and equal amounts of active materials therefore will not necessarily result in equal capacities (mAh/cm2).

Thus, an embodiment of the present invention relates to the method as described herein, wherein the anode comprises an average anode active material mass loading of less than 1 mg/cm² and the second cathode comprises an average cathode active material mass loading of up to 25mg/cm².

Another embodiment of the present invention relates to the method as described herein, wherein the ratio of the active material mass loading of the anode to the active material mass loading of the second cathode is in the range of about 0.01 to about 0.5.

The concept of the pre-intercalated anode described herein is not limited to anodes comprising any specific type of active material. In principle, any active material, or combinations thereof, capable of intercalating lithium ions may be used.

Therefore, an embodiment of the present invention relates to the method as described herein, wherein the anode active material comprises one or more materials selected from the group consisting of non-graphitizing carbon, graphite, silicon, silicon alloy, silicon oxide (SiOₓ, wherein x is smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), MXenes (e.g. V₂CTₓ, Nb₂CTₓ, Ti₂CTₓ, and Ti₃C₂Tₓ), or combinations thereof.

The term “MXenes”, as used herein, represents two-dimensional inorganic compounds making up a-few-atoms-thick layers of transition metal carbides, nitrides, or carbonitrides. MXenes combine the metallic conductivity of transition metal carbides with a hydrophilic character.

Another embodiment of the present invention relates to the method as described herein, wherein the anode active material comprises one or more materials selected from the group consisting of graphite, silicon, silicon oxide (SiOₓ, wherein x is smaller than or equal to 2), and non-graphitizing carbon, and combinations thereof.

In standard lithium ion batteries, carbonaceous materials such as artificial graphite, natural graphite, and hard carbon capable have commonly been utilised as an anode active material. In particular, graphite has favourable structural stability and great lithium ion storage capacity, which makes it a good active material. The same traits are desired for the lithium hybrid anode described herein.

Thus, an embodiment of the present invention relates to the method as described herein, wherein the anode active material is a carbonaceous material.

Another embodiment of the present invention relates to the method as described herein, wherein the carbonaceous material is selected from the group consisting of Synthetic graphite, natural graphite, mesophase carbon, soft carbon, hard carbon, amorphous carbon, polymeric carbon, coke, meso-porous carbon, carbon fiber, graphite fiber, carbon nano-fiber, carbon nano-tube, and expanded graphite platelets or nano graphene platelets containing multiple graphene planes bonded together, and combinations thereof.

Another embodiment of the present invention relates to the method as described herein, wherein the anode active material is selected from the group consisting of graphite-Si, graphite-SiOₓ (wherein x is smaller than or equal to 2), and graphite-non-graphitizing carbon.

A preferred embodiment of the present invention relates to the method as described herein, wherein the anode active material is graphite, preferably synthetic graphite. The graphite used for the anode active material may be in the form of amorphous, planar, flaky, spherical or fibrous graphite.

The anode active material described above is preferably contained in an amount of about 70 wt% to about 99.5 wt%, such as about 80 wt% to 99 wt% with respect to the total weight of the anode.

The partial charging of the anode to prepare the pre-intercalated anode involves charging at a capacity which will not cause deposition of metallic lithium on the anode active material. At this stage, all lithium ions are intercalated in the anode active material. Subsequent to partial charging and assembly of the secondary electrochemical cell, charging of the final secondary electrochemical cell results in deposition/plating of metallic lithium on the anode active material.

Accordingly, an embodiment of the present invention relates to the method as described herein, wherein, in the step (iv), the pre-intercalated anode does not comprise any metallic lithium.

Another embodiment of the present invention relates to the method as described herein, wherein, in the step (v), charging the secondary electrochemical cell causes a metallic lithium layer to be deposited on the anode active material.

Preferably, after step (v), the ratio of intercalated and plated lithium on the pre-intercalated anode to capacity of the cathode is in the range of about 1.05 to about 1.8.

Preferably, the anode active material is a porous material, thereby allowing deposition of metallic lithium to take place in the cavities/pores thereof. Confinement of the metallic lithium reduces the volume change of the anode normally observed during deposition of metallic lithium. Further, the anode active material may have a large surface area which assist in distributing the metallic lithium and thereby limit local current densities that may act as starting point for dendrite formation.

Thus, an embodiment of the present invention relates to the method as described herein, wherein the anode active material layer have a specific surface area in the range of about 0.1 m 2/g to about 1000 m 2/g, such as about 10 m 2/g to about 500 m 2/g, such as about 20 m 2/g to about 100 m 2/g.

Another embodiment of the present invention relates to the method as described herein, wherein the anode active material layer have a specific surface area of at least about 10 m 2/g, such as at least about 20 m 2/g, such as at least about 100 m 2/g.

A further embodiment of the present invention relates to the method as described herein, wherein the thickness of the metallic lithium layer is in the range of about 1% to about 1000% of the thickness of the anode active material layer, such as about 5% to about 100%, such as about 10% to about 50%.

Yet another embodiment of the present invention relates to the method as described herein, wherein the thickness of the metallic lithium layer is no more than about 100%, such as no more than about 50%, no more than about 10%, of the thickness of the anode active material layer.

Binders are added to electrodes to facilitate attachment of the active material particles to each other, and also to connect the active material to the current collector. The anode described herein may comprise one or more binders, and is not limited to any particular type of binder. The binder can be included in an amount similar to that used in other secondary lithium ion cells.

Thus, an embodiment of the present invention relates to the method as described herein, wherein the anode comprises a binder.

Another embodiment of the present invention relates to the method as described herein, wherein the binder is selected from the group consisting of polyvinyl alcohol, carboxymethyl cellulose, hydroxypropylcellulose, diacetylcellulose, polyvinyl chloride, carboxylated polyvinyl chloride, polyvinyl fluoride, polymer containing ethylene oxide, polyvinylpyrrolidone, polyurethane, polytetrafluoroethylene, polyvinylidene fluoride, polyvinylidene difluoride, polyethylene, polypropylene, styrene-butadiene rubber, acrylate-butadiene rubber, epoxy resin, and nylon, and combinations thereof.

A further embodiment of the present invention relates to the method as described herein, wherein the amount of binder is in the range of about 0.1 wt % to about 5 wt %, such as about 0.1 wt % to about 3 wt %, such as about 0.1 wt % to about 1.5 wt %, with respect to the total weight of the anode.

Optionally, the anode may comprise a conductive material. Conductive materials are used as additives to anodes to impart conductivity to the anode. The anode is not limited to any particular type of conductive material, as long a it does not inadvertently induce a chemical change to the electrochemical cell.

An embodiment of the present invention relates to the method as described herein, wherein the anode comprises a conductive material.

Another embodiment of the present invention relates to the method as described herein, wherein the conductive material is selected from the group consisting of a carbon-based material, such as natural graphite, artificial graphite, carbon black, acetylene black, ketjen black, and carbon fiber, a metal-based material, such as metal powders or metal fibers such as copper, nickel, aluminium, and silver, and conductive polymers, such as polyphenylene derivatives, and a combinations thereof.

Another embodiment of the present invention relates to the method as described herein, wherein the conductive material is carbon black or carbon nanotubes (CNT). The anode and second cathode current collectors are not limited to any specific material or form as long as it has conductivity without causing chemical changes in the battery. Therefore, an embodiment of the present invention relates to the method as described herein, wherein the anode comprises a current collector.

Another embodiment of the present invention relates to the method as described herein, wherein the current collector is of a material selected from the group consisting of metal foil or metal mesh, such as copper foil or copper mesh, a polymer coated with a conducting material, preferably a metal, a graphite sheet, a sheet comprising carbon nanotubes (CNT), graphene, graphene oxide, carbon nanofibers, and carbon paper, or combinations thereof.

The current collector may be formed in various forms such as a film, a sheet, a foil, a net, a porous body, a foaming body, and a non-woven fabric structure. The thickness of the current collector may be in the range of about 2 μm to about 1000 μm.

Charging and discharging of the secondary electrochemical cell involves transport of lithium ions from the cathode to the anode and vice versa. Lithium ions are carried in an electrolyte. Typically, the electrolyte comprises a lithium salt and one or more solvents, preferably one solvent. The choice of electrolyte may be guided by the rest of the components, such as active material.

Thus, an embodiment of the present invention relates to the method as described herein, wherein, in step (iii) and/or step (v), lithium ions are transported in an electrolyte.

Another embodiment of the present invention relates to the method as described herein, wherein the electrolyte comprises at least one lithium salt and at least one solvent.

Yet another embodiment of the present invention relates to the method as described herein, wherein the at least one lithium salt is selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl) imide (LiFTFSI), lithium bis (pentafluoroethanesulfonyl) imide (LiBETI), lithium (pentafluoroethanesulfonyl) (trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato) phosphate (LiDFOP), lithium tetrafluoro(oxalato) phosphate (LiTFOP), lithium tetrafluoroborate (LiBF₄), lithium nitrate (LiNO₃) lithium 2-trifluoromethyl-4,5-dicyanoimidazole (LiTDI).

The concentration of the lithium salt can be adjusted to optimise performance of the secondary electrochemical cell. For efficient transfer of lithium ions the electrolyte should have sufficient conductivity and viscosity.

Thus, an embodiment of the present invention relates to the method as described herein, wherein the concentration of lithium salt is in the range of about 0.1 M to about 2.0 M.

Preferably, the solvent of the electrolyte is a non-aqueous organic solvent. The non-aqueous organic solvent may include a carbonate-based, ester-based, ether-based, ketone-based, alcohol-based, or aprotic solvent.

Therefore, an embodiment of the present invention relates to the method as described herein, wherein the at least one solvent is a non-aqueous organic solvent.

Another embodiment of the present invention relates to the method as described herein, wherein the at least one solvent is selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR 13-TFSI), 1-butyl-1-methylpyrrolidinium bis(fluorosulfonyl)imide (PYR 14-FSI), 1-butyl-1-methylpyrrolidinium bis(trifluoromethanesulfonyl)imide (PYR 14-TFSI), 1-ethyl-3-methylimidazolium bis(fluorosulfonyl)imide (EMIM-FSI), 1-ethyl-3-methylimidazolium bis(trifluoromethanesulfonyl) imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

The active material of the first and/or second cathode is not limited to any specific material, but may comprise one or more compounds capable of intercalating and de-intercalating lithium ions. The active material of the first and/or second cathode may comprise a lithium composite metal oxide including one or more metals, such as cobalt, manganese, nickel, or aluminum, and lithium, more preferably a lithium composite comprising cobalt, manganese, and nickel, and lithium.

Thus, an embodiment of the present invention relates to the method as described herein, wherein the first and/or second cathode comprise a cathode active material selected from the group consisting of lithium cobalt oxide, lithium nickel oxide, lithium manganese oxide, lithium transition metal oxide, lithiated oxide of transition metal mixture, lithiated oxide of a transition metal, lithiated oxide of transition metal mixture, lithium iron phosphate, lithium vanadium phosphate, lithium manganese phosphate, a lithiated transition metal phosphate, a chalcogen compound, sulfur-containing molecule, sulfur-containing compound, sulfur-carbon polymer, lithium copper oxyphosphate (Cu₄O(PO₄)₂), and combinations thereof.

Exemplary positive active materials include lithium iron phosphate, nickel-cobalt-manganese (NMC) composite oxides and lithium NMC (Li-NMC) composite oxides such as lithium cobalt oxide (LiCoO₂), lithium nickel oxide (LiNiO₂), lithium manganese oxide (LiMn₂O₄), lithium nickel cobalt oxide (LiNiₓCO₁₋ₓO₂ (0<x<1) or LiNi_{1—x—y}CoₓAl_{y}O2 ((0<x≤0.2, 0<y≤0.1)) as well as lithium nickel cobalt manganese (NCM) oxide (LiNi_{1—x—y}CoₓMn_{y}O2 (0<x+y<1)).

Another embodiment of the of the present invention relates to the method as described herein, wherein the second cathode comprises a lithium-nickel-manganese-cobalt-based oxide of the formula Li(Ni_{P}Co_{q}Mnₗ)O₂, wherein 0<p<1, 0<q<1, 0<l<1, p+q+l=1.

The first cathode material may be any of the cathode materials set out above. Alternatively, as the first cathode material is not incorporated into the final cell, there is not the need to use the high performance, costly material that might be used for the second cathode.

In some variants of the method, no lithium metal is utilised as lithium ion source in the method. Thus, there is no need to handle any lithium metal during manufacture which obviates the requirement for special equipment and moisture controlled conditions to handle the brittle and volatile metal. This keeps the production simple, fast and cost-effective.

Thus, an embodiment of the present invention relates to the method as described herein, wherein the first cathode does not comprise lithium metal.

However, the pre-intercalated anode of the method is produced in a separate step prior to assembly of the secondary electrochemical cell, and therefore the actual assembly of the secondary electrochemical cell may be performed using conventional mass production processes, such as those typically used for assembly of Li-ion batteries. Therefore, the use of lithium metal in the first cathode may be acceptable for some production processes.

Accordingly, an embodiment of the present invention relates to the method as described herein, wherein the first cathode comprises lithium metal.

The secondary electrochemical cell preferably comprises a separator to separate the anode and second cathode. The separator is permeable to lithium ions. Any separator may be used, but it is preferred to use a material with high electrolyte impregnation ability and low resistance to migration of electrolyte ions.

Accordingly, an embodiment of the present invention relates to the method as described herein, wherein the secondary electrochemical cell comprises a separator positioned between the anode and the second cathode.

Another embodiment of the present invention relates to the method as described herein, wherein the separator comprises a material selected from the group consisting of polyethylene film, a polypropylene film, a poly (tetrafluoroethylene) film, a polyvinyl chloride film, nonwoven cotton fibers, nonwoven nylon fibers, nonwoven polyester fibers, glass fibers, ceramic, rubber, asbestos, wood, and combinations thereof.

The secondary electrochemical cells prepared by the method described herein showed surprisingly improved cycle life compared to cells without a pre-intercalated anode. The cycle life may be quantified by the capacity retention over a fixed number of cycles. For the purpose of determining the cycle life of a secondary electrochemical cell, it is common to define end life of the battery at the point when the cell reaches a capacity retention of 80% with respect to a first cycle chosen after cell formation and pre-conditioning.

Thus, an embodiment of the present invention relates to the method as described herein, wherein the secondary electrochemical cell has a capacity retention of at least 80% after 100 charge/discharge cycle, such as after 125 charge/discharge cycles, such as after 150 charge/discharge cycle, such as after 175 charge/discharge cycles, preferably after 200 charge/discharge cycle.

Another embodiment of the present invention relates to the method as described herein, wherein the secondary electrochemical cell has a capacity retention of at least 80% after 200 charge/discharge cycles, such as at least 85% after 200 charge/discharge cycles, such as at least 90% after 200 charge/discharge cycles, such as at least 95% after 200 charge/discharge cycles.

The process for preparing the anodes and cathodes described herein are not limited to any specific process. One non-limiting way of preparing the anode and cathode is to mix active material, binder, and optionally a conductive material in an organic solvent to obtain a electrode slurry. It is preferred to use an organic solvent that uniform disperses the components of the electrode and readily evaporates. The slurry is then coated and dried on a current collector and optionally subject to calendaring.

An aspect of the present invention relates to a secondary electrochemical cell obtainable by a method as described herein.

The secondary electrochemical cells obtained by the method described herein can be stacked and used in a battery. Briefly, a stack of secondary electrochemical cells can be placed in a casing and electrolyte is injected into the case, which is the sealed. The battery is then charged to complete intercalation and deposition of metallic lithium on the pre-intercalated anode, thereby producing a lithium secondary battery.

Thus, an aspect of the present invention relates to a lithium secondary comprising a secondary electrochemical cell as described herein.

Another aspect of the present invention relates to an electrochemical cell assembly comprising:
a pre-intercalated anode comprising an anode active material;
a cathode comprising a lithium ion source;
optionally, a separator;
   wherein the ratio of the pre-intercalated anode capacity to cathode capacity (N/P ratio) is less than 1.

An embodiment of the present invention relates to the electrochemical cell assembly as described herein, wherein the intercalation occupation of the pre-intercalated anode is below about 0.8, preferably from about 0.1 to about 0.6, more preferably about 0.1 to about 0.4.

Another embodiment of the present invention relates to the electrochemical cell assembly as described herein, wherein the N/P ratio is in the range of about 0.1 to about 0.8, such as about 0.2 to about 0.6, such as about 0.2 to about 0.5.

A further embodiment of the present invention relates to the electrochemical cell assembly as described herein, wherein the electrochemical assembly has not yet been charged.

The electrochemical cell assembly may also be provided as a final electrochemical cell, which has been charged.

Thus, another aspect of the present invention relates to an electrochemical cell comprising:
a pre-intercalated anode comprising an anode active material;
a cathode comprising a lithium ion source;
optionally, a separator;
   wherein, when the cell is charged, the amount of intercalated and plated lithium on the pre-intercalated anode is greater than the capacity of the cathode.

Accordingly, when the electrochemical cell is charged, the amount of lithium (intercalated or plated) in the electrochemical cell is higher than the capacity of the cathode. The intercalation occupation of the pre-intercalated anode before initial charging will guide how much higher the amount of lithium in the electrochemical cell is compared to the capacity of the cathode.

Viewed differently, the amount of lithium (intercalated or plated) and amount of lithium in the cathode is typically higher than the capacity of the cathode.

Thus, an embodiment of the present invention relates to the electrochemical cell as described herein, wherein the ratio of intercalated and plated lithium on the pre-intercalated anode and the amount of lithium in the cathode to the capacity of the cathode is in the range of about 1.05 to about 1.8, such as about 1.05 to about 1.7, such as about 1.05 to about 1.6, preferably about 1.05 to about 1.5, preferably about 1.1 to about 1.4.

Another embodiment of the present invention relates to the electrochemical cell as described herein, wherein the electrochemical cell does not comprise any metallic lithium prior to initial charging.

Yet another embodiment of the present invention relates to the electrochemical cell as described herein, wherein all the lithium ions in the electrochemical cell are intercalated prior to initial charging.

A further embodiment of the present invention relates to the electrochemical cell as described herein further comprising an electrolyte.

The listing or discussion of an apparently prior published document in this specification should not necessarily be taken as an acknowledgement that the document is part of the state of the art or is common general knowledge.

Preferences, options and embodiments for a given aspect, feature or parameter of the invention should, unless the context indicates otherwise, be regarded as having been disclosed in combination with any and all preferences, options and embodiments for all other aspects, features and parameters of the invention. This is especially true for the description of the method for preparing the lithium hybrid anode and all its features, which may readily be part of the final lithium secondary cell obtained by the method as described herein.

### EXAMPLES

### Example 1

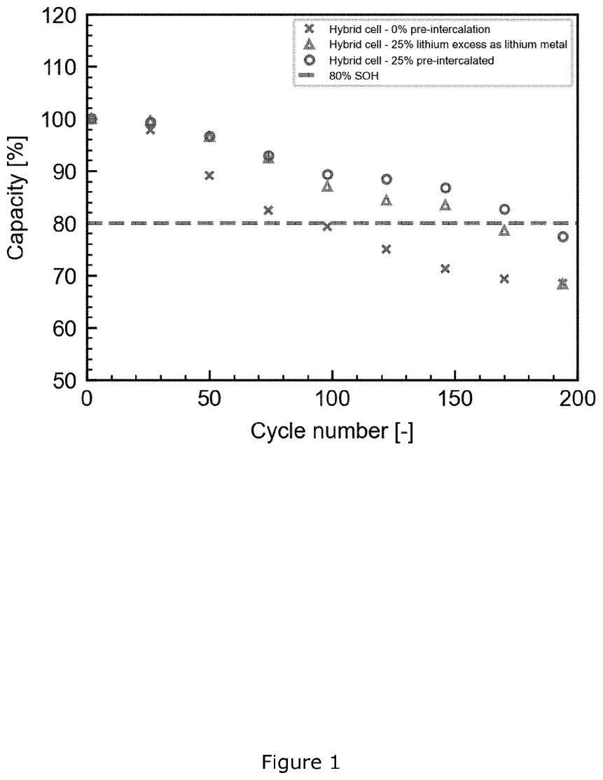

Secondary cells were made using an LiNMC cathode material and a carbon-based anode material. The N/P ratios for the cells were 0.5. Two cells were constructed with a ratio of intercalated and plated lithium on the anode to the capacity of the cathode of 1.25 (i.e. 25% excess lithium in the cell compared to cathode capacity), with one of the comparative cells being prepared with no excess lithium (i.e. no pre-intercalation or plated lithium on the anode). One cell was constructed with an anode pre-intercalated to 50% capacity (50% intercalation occupation) in accordance with the method of the disclosure (shown as 25% pre-intercalated in FIG. 1). The comparative cells were prepared incorporated into the cell without any pre-intercalation or lithium metal on the anode (shown as 0% pre-intercalated in FIG. 1), or prepared with 25% lithium excess added as lithium metal deposited (i.e. not intercalated) on the anode active material layer (shown as 25% lithium excess as lithium metal in FIG. 1).

The cells were repeatedly charged and discharged at a rate of 0.5 C and 1 C, respectively, using a multilayer pouch cell format. The capacity % and cycle number are shown in FIG. 1. The cell having the pre-intercalated anode shows higher capacity retention through the cell cycles.

1. A method for preparing a secondary electrochemical cell, said method comprising the steps of:
(i) providing an anode comprising an anode active material layer;
(ii) providing a first cathode comprising a first lithium ion source;
(iii) partially charging the anode active material layer with lithium ions using the first lithium ion source of said first cathode to provide a pre-intercalated anode;
(iv) assembling a secondary electrochemical cell comprising said preintercalated anode and a second cathode comprising a second source of lithium ions; and
(v) optionally, charging said secondary electrochemical cell; wherein, in the step (iv), the ratio of the pre-intercalated anode capacity to second cathode capacity (N/P ratio) is less than 1.

2. The method according to claim 1, wherein the intercalation occupation of the preintercalated anode is below about 0.8, preferably from about 0.1 to about 0.6, more preferably about 0.1 to about 0.4.

3. The method according to claim 1, wherein the N/P ratio is in the range of about 0.1 to about 0.8, such as about 0.2 to about 0.6, such as about 0.2 to about 0.5.

4. The method according to claim 1, wherein the second cathode capacity is in the range of about 2 mAh/cm² to about 20 mAh/cm², such as about 2 mAh/cm² to about 15 mAh/cm², such as about 4 mAh/cm² to about 15 mAh/cm².

5. The method according to claim 1, wherein the anode capacity is in the range of about 1 mAh/cm² to about 10 mAh/cm², such as about 2 mAh/cm² to about 8 mAh/cm².

6. The method according to claim 1, wherein the ratio of the active material mass loading of the anode to the active material mass loading of the cathode is in the range of about 0.01 to about 0.5.

7. The method according to claim 1, wherein the anode active material comprises one or more materials selected from the group consisting of non-graphitizing carbon, graphite, silicon, silicon alloy, silicon oxide (SiOx, wherein x is smaller than or equal to 2), silicon-carbon composite, a transition metal dichalcogenide (e.g. titanium disulfide (TiS2)), tin-cobalt alloy, lithium titanate oxide (LTO, Li4TisO12), MXenes (e.g. V2CTx, Nb2CTx, Ti2CTx, and Ti3C2Tx), or combinations thereof.

8. The method according to claim 1, claims, wherein the anode active material is a carbonaceous material.

9. The method according to claim 1, wherein the anode active material is graphite, preferably synthetic graphite.

10. The method according to claim 1, wherein, in the step (iv), the pre-intercalated anode does not comprise any metallic lithium.

11. The method according to claim 1, wherein, in the step (v), charging the secondary electrochemical cell causes a metallic lithium layer to be deposited on the anode active material.

12. The method according to claim 1, wherein, in step (iii) and/or step (v), lithium ions are transported in an electrolyte.

13. The method according to claim 12, wherein the electrolyte comprises at least one lithium salt and at least one solvent.

14. The method according to claim 1, wherein, after step (v), the ratio of intercalated and plated lithium on the pre-intercalated anode to capacity of the cathode is in the range of about 1.05 to about 1.8.

15. A secondary electrochemical cell obtainable by the method of claim 1.

16. An electrochemical cell assembly comprising:
a pre-intercalated anode comprising an anode active material;
a cathode comprising a lithium ion source;
optionally, a separator;
wherein the ratio of the pre-intercalated anode capacity to cathode capacity (N/P ratio) is less than 1.

17. An electrochemical cell comprising:
a pre-intercalated anode comprising an anode active material;
a cathode comprising a lithium ion source;
optionally, a separator;
wherein, when the cell is charged, the amount of intercalated and plated lithium on the pre-intercalated anode is greater than the capacity of the cathode.

18. The electrochemical cell according to claim 17, wherein the ratio of intercalated and plated lithium on the pre-intercalated anode and the amount of lithium in the cathode to the capacity of the cathode is in the range of about 1.05 to about 1.8
